(19) United States
(12) Patent Application Publication
(10) Pub. No.: US 2026/0170953 A1
(43) Pub. Date: Jun. 18, 2026

(54) DRIVING ASSISTANCE SYSTEM, DRIVING ASSISTANCE METHOD, AND RECORDING MEDIUM

(71) Applicant: NEC Corporation, Minato-ku, Tokyo (JP)

(72) Inventor: Isamu TAKEDA, Tokyo (JP)

(73) Assignee: NEC Corporation, Minato-ku, Tokyo (JP)

(21) Appl. No.: 19/128,627

(22) PCT Filed: Nov. 30, 2022
(86) PCT No.: PCT/JP2022/044092

§ 371 Date: May 9, 2025

(51) Int. Cl. G08G 1/0967; G06V 20/58

(52) U.S. Cl. CPC G08G 1/0967; G06V 20/58

(57) ABSTRACT

A driving assistance system includes: at least one memory storing instructions; and at least one processor configured to execute the instructions to: acquire a video of a current road; detect a difference between a video in a case where a situation of the road is good and the video of the current road; and display a notification based on the difference to a user at a position relevant to the difference in a display region of a head-up display.

### TECHNICAL FIELD

The present disclosure relates to a driving assistance system and the like.

### BACKGROUND ART

There are a case where a rainfall amount is large and a case where a snowfall amount is large as in a linear precipitation zone. For example, PTL 1 describes that a depth of a flooded part is calculated, and a warning image relevant to the calculated depth is displayed to be superimposed on an image of a camera.

PTL 2 describes that attention to a change in the shape of a road is displayed on a digital tachograph.

PTL 3 describes displaying a reference image and an abnormality candidate image in a case where there is an abnormality in a measurement result of a road plane.

### CITATION LIST

### Patent Literature

PTL 1: JP 2021-152917 A
PTL 2: JP 2022-133816 A
PTL 3: JP 2015-041188 A

### Summary of Invention

### Technical Problem

When the rainfall amount or the snowfall amount is large, it is still difficult to drive, and thus driving may be dangerous.

An object of the present disclosure is to provide a driving assistance system and the like for achieving driving safety.

### Solution to Problem

A driving assistance system according to one aspect of the present disclosure includes an acquisition means for acquiring a video of a current road, a detection means for detecting a difference between a video in a case where a situation of the road is good and the video of the current road, and an output control means for displaying a notification based on the difference to a user at a position relevant to the difference in a display region of a head-up display.

A driving assistance method according to one aspect of the present disclosure includes acquiring a video of a current road, detecting a difference between a video in a case where a situation of the road is good and the video of the current road, and displaying a notification based on the difference to a user at a position relevant to the difference in a display region of a head-up display.

A program according to one aspect of the present disclosure causes a computer to execute acquiring a video of a current road, detecting a difference between a video in a case where a situation of the road is good and the video of the current road, and displaying a notification based on the difference to a user at a position relevant to the difference in a display region of a head-up display.

The program may be stored in a non-transitory computer-readable recording medium.

### Advantageous Effects of Invention

According to the present disclosure, driving safety can be achieved.

### BRIEF DESCRIPTION OF DRAWINGS

FIG. 1 is a block diagram illustrating a configuration example of a driving assistance system according to a first example embodiment.

FIG. 2 is a flowchart illustrating an operation example of a driving assistance system according to the first example embodiment.

FIG. 3 is an explanatory diagram illustrating an example of connection between the driving assistance system and other devices.

FIG. 4 is a block diagram illustrating a configuration example of a driving assistance system according to a second example embodiment.

FIG. 5 is an explanatory diagram illustrating an example of a current road with a puddle.

FIG. 6 is an explanatory diagram illustrating a comparative example of a video of a current road and a video of the road in a case where the road situation is good.

FIG. 7 is an explanatory diagram illustrating a display example in a case where a risk level is determined to be low based on the depth of a puddle.

FIG. 8 is an explanatory diagram illustrating a display example in a case where a risk level is determined to be high based on the depth of a puddle.

FIG. 9 is an explanatory diagram illustrating an example of a current road with accumulated snow.

FIG. 10 is an explanatory diagram illustrating a comparative example of a video of a current road and a video of the road in a case where the road situation is good.

FIG. 11 is an explanatory diagram illustrating an example in which a complementary lane is displayed.

FIG. 12 is an explanatory diagram illustrating an example in which guidance to a bypass is displayed.

FIG. 13 is a flowchart illustrating an operation example of the driving assistance system according to the second example embodiment.

FIG. 14 is an explanatory diagram illustrating an example in which the driving assistance system includes a plurality of servers.

FIG. 15 is an explanatory diagram illustrating a hardware configuration example of a computer.

### EXAMPLE EMBODIMENT

Hereinafter, example embodiments of a driving assistance system, a driving assistance method, a program, and a non-transitory recording medium recording the program according to the present disclosure will be described in detail with reference to the drawings. The present example embodiment does not limit the disclosed technology.

In each example embodiment, a head-up display is installed in a vehicle, and a type of the head-up display is not particularly limited.

For example, a head-up display displays information on a windshield by projecting the information on the windshield.

### First Example Embodiment

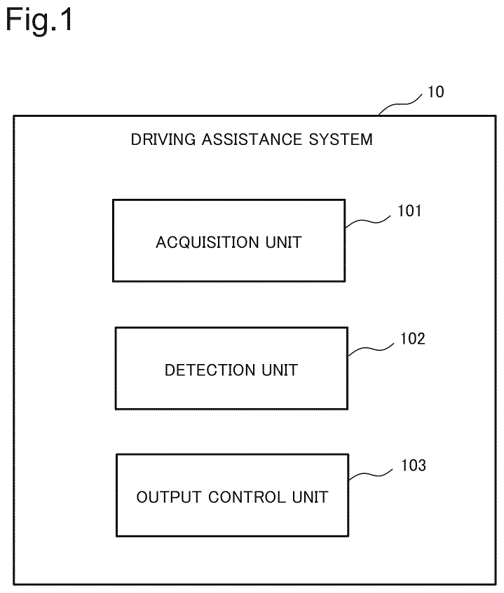

First, in a first example embodiment, a basic function of a driving assistance system will be described. FIG. 1 is a block diagram illustrating a configuration example of the driving assistance system according to the first example embodiment. A driving assistance system 10 includes an acquisition unit 101, a detection unit 102, and an output control unit 103.

The acquisition unit 101 acquires a video of the current road. Specifically, for example, the acquisition unit 101 acquires a video of the current road from an imaging device installed in the vehicle. For example, the imaging device captures an image of a road in front of the vehicle through a windshield of the vehicle. Alternatively, for example, the acquisition unit 101 acquires a video of the current road from an imaging device installed on the road. For example, the imaging device may be provided in a roadside device installed on a road. In a case where a video of an imaging device installed in a roadside device is used, it is possible to check a state of a current road slightly ahead in a traveling direction of the vehicle from a current position of the vehicle.

The detection unit 102 detects a difference between a video obtained in a case where the situation of the road is good and a video of the current road. It is assumed that the video in a case where the situation of the road is good is stored in a storage means or the like and prepared in advance. Specifically, the detection unit 102 aligns the video of the current road with the video in a case where the situation of the road is good, and detects the difference. For example, the detection unit 102 detects a puddle, accumulated snow, a fallen rock, and the like. As a detection method by the detection unit 102, an existing technology may be used. The detection unit 102 may detect the size of a puddle, the depth of accumulated snow, and the size of a fallen rock. The size of the puddle includes the depth of the puddle, the vertical and horizontal sizes with respect to the ground, and the like, but in the following description, the depth of the puddle will be described as an example of the size of the puddle.

The output control unit 103 displays, for a user, a notification based on a difference, the display being at a position which is in a display region of a head-up display and which is relevant to the difference. The user is, for example, a driver. In the following description, the driver will be described as an example. For example, the position relevant to the difference is a position where there is a difference or a vicinity of a position where there is a difference visible from the driver. The notification may be, for example, information regarding calling attention.

For example, the output control unit 103 may display information indicating the difference as a notification. The information indicating the difference may be information indicating which type the difference is. The difference between the puddle, the accumulated snow, and the fallen rock may be represented by a graphic of at least one of a color, a shape, and a pattern. For example, a puddle may be represented by blue, snow may be represented by yellow, and a fallen rock may be represented by red. The information indicating the difference may be the depth of the detected puddle, the depth of accumulated snow, and the size of fallen rock. The detected depth of the puddle, the depth of the accumulated snow, and the size of the fallen rock may be represented by at least one graphic of a color, a shape, and a pattern, for example. For example, when the depth of the puddle is less than 4 cm (centimeter), the puddle may be represented by a blue circle, and when the depth is 4 cm or more, the puddle may be represented by a blue triangle.

For example, the output control unit 103 may display an instruction regarding driving relevant to the difference as a notification. For example, in a case where a puddle is detected, the output control unit 103 may display an instruction regarding driving according to the depth of the puddle. For example, in a case where accumulated snow is detected, the output control unit 103 may display an instruction regarding operation according to the depth of the accumulated snow. For example, in a case where a fallen rock is detected, the output control unit 103 may display an instruction regarding driving according to the size of the fallen rock. The instruction regarding driving may be represented by characters such as “STOP”, “DECELERATION”, “DETOUR”, “SLOW DOWN”, “HALT”, “CAUTION”, and “WATCH OUT FOR FALLING ROCKS”. The instruction regarding driving may be represented by a graphic of at least one of a color, a shape, and a pattern. For example, taking color as an example, a blue graphic may represent “SLOW DOWN” and a red graphic may represent “HALT”. Taking a shape as an example, a triangle graphic may represent “SLOW DOWN” and a square graphic may represent “HALT”. Taking a pattern as an example, a striped graphic may represent “SLOW DOWN”, and a dotted graphic may represent “HALT”. For example, in a case where characters used for a road sign are displayed as an instruction regarding driving, colors, shapes, and patterns used for the road sign may also be used as colors, shapes, and patterns.

The information indicating which type the difference is, the information regarding the size and shape such as the size of the puddle, the depth of the accumulated snow, and the size of the fallen rock, and the instruction regarding the operation may be combined and matched graphically. For example, which difference is represented by a color, information regarding a size and a shape may be represented by a pattern, and an instruction regarding driving may be represented by a shape. As described above, the universal design may represent a difference or a combination of instructions related to driving according to the difference. As a result, the driver can grasp the danger at a glance.

### Flowchart

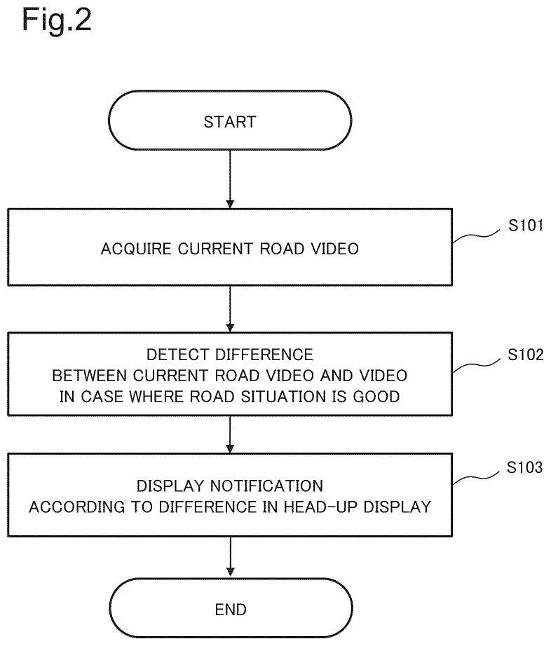

FIG. 2 is a flowchart illustrating an operation example of the driving assistance system 10 according to the first example embodiment. The acquisition unit 101 acquires a video of the current road (step S101). Next, the detection unit 102 detects a difference between a video obtained in a case where the situation of the road is good and a video of the current road (step S102). The output control unit 103 displays, for a driver, a notification based on a difference, the display being at a position which is in a display region of a head-up display and which is relevant to the difference (step S103).

As described above, in the first example embodiment, the driving assistance system 10 displays a notification based on a difference between a video in a case where the situation of the road is good and a video of the current road at a position relevant to the difference in the display region of the head-up display. As a result, it is possible to notify danger such as a puddle, accumulated snow, or a fallen rock. Therefore, driving safety can be achieved.

### Second Example Embodiment

Next, a second example embodiment will be described in detail with reference to the drawings. In the second example embodiment, a specific display example of a head-up display and an example of determining a risk level based on a detected difference will be described. Hereinafter, description of content overlapping with the above description will be omitted to the extent that the description of the second example embodiment is not unclear.

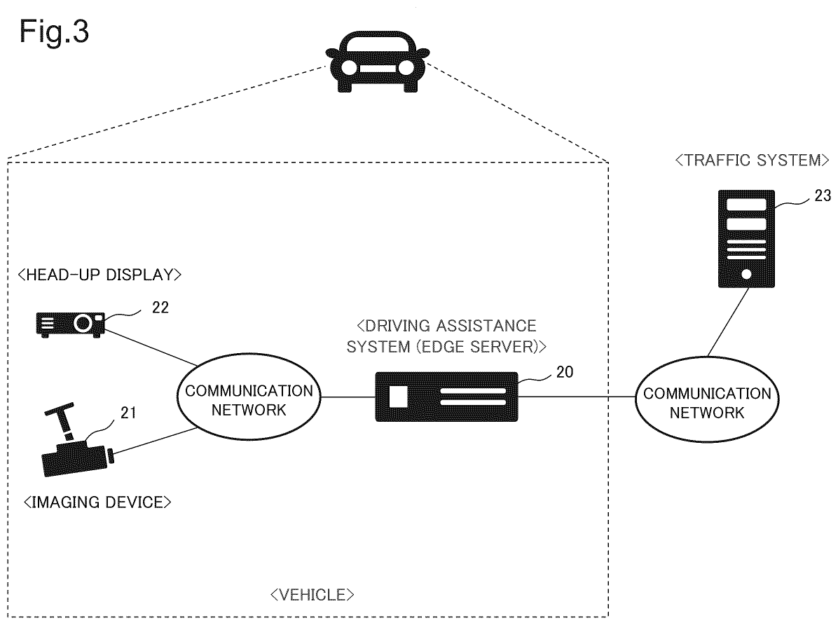

FIG. 3 is an explanatory diagram illustrating an example of connection between the driving assistance system and other devices.

Here, an example in which a driving assistance system 20 is achieved by an edge server or the like in the vehicle will be described. Therefore, it is assumed that the driving assistance system 20 is installed in the vehicle.

For example, the driving assistance system 20 is connected to an imaging device 21, a head-up display 22, and the like via a communication network in the vehicle. For example, the imaging device 21 captures an image of a road in front of the vehicle through a windshield of the vehicle. The number of imaging devices 21 is not particularly limited.

In FIG. 3, an example in which the driving assistance system 20 is achieved by the edge server in the vehicle has been described. However, the driving assistance system 20 may be achieved by an edge server in the vehicle, a server outside the vehicle, or the like.

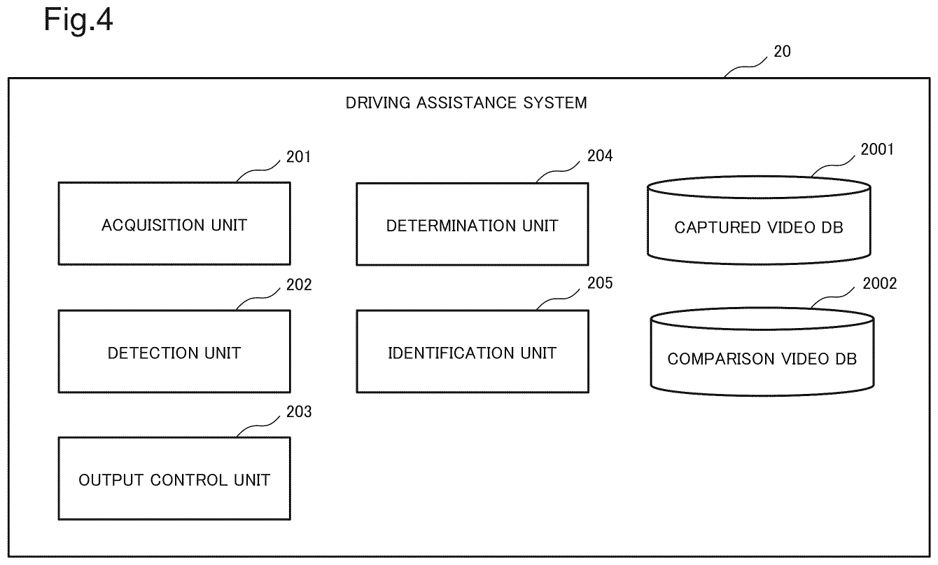

FIG. 4 is a block diagram illustrating a configuration example of the driving assistance system 20 according to the second example embodiment. The driving assistance system 20 includes an acquisition unit 201, a detection unit 202, an output control unit 203, a determination unit 204, and an identification unit 205.

The driving assistance system 20 is different from the driving assistance system 20 according to the first example embodiment in that the determination unit 204 and the identification unit 205 are added. The acquisition unit 201 may have the function of the acquisition unit 101 according to the first example embodiment as a basic function. The detection unit 202 may have the function of the detection unit 102 described in the first example embodiment as a basic function. The output control unit 203 may have the function of the output control unit 103 described in the first example embodiment as a basic function.

The driving assistance system 20 includes, for example, a captured video database (DB) 2001 and a comparison video DB 2002. The captured video DB 2001 stores, for example, a video of the current road captured in real time. The comparison video DB 2002 stores, for example, a video of a road captured in the past in a case where the situation of the road is good.

The acquisition unit 201 acquires a video of the current road. As described in the first example embodiment, for example, the acquisition unit 201 acquires a video of the current road from the imaging device 21 installed in the vehicle. For example, the acquisition unit 201 stores the acquired video in the captured video DB 2001. Alternatively, as described in the first example embodiment, for example, the acquisition unit 201 acquires a video of the current road from the imaging device 21 installed on the road via the communication network.

The detection unit 202 detects a difference between a video obtained in a case where the situation of the road is good and a video of the current road. The video in a case where the situation of the road is good is stored in the comparison video DB 2002. The difference is a difference in road situation that causes trouble in driving while traveling on the road. For example, the detection unit 202 detects a puddle, accumulated snow, a fallen rock, and the like as the difference. Furthermore, the detection unit 202 detects the depth of a puddle, the depth of accumulated snow, the size of a fallen rock, and the like. As a detection method by the detection unit 202, an existing technology may be used.

The output control unit 203 displays, for a driver, a notification based on a difference, the display being at a position which is in a display region of a head-up display 22 and which is relevant to the difference. As described in the first example embodiment, for example, the position relevant to the difference is a position where there is a difference or a vicinity of a position where there is a difference visible from the driver.

Here, in a display device of a car navigation or a display device of a terminal device such as a smartphone, other videos may be superimposed and displayed on a captured video or a video such as a map. In such a case, since it is not superimposed on the road viewed by the driver, it is conceivable that even if a large image or the like is superimposed and displayed, the influence on driving is small. On the other hand, the head-up display 22 displays the information so as to be superimposed on the road actually viewed by the driver. Unlike a display device of a terminal device such as a car navigation device or a smartphone, when a large image or the like is displayed on the head-up display 22, a field of view of a driver may be obstructed. For this reason, depending on the display, driving may be hindered.

Therefore, the output control unit 203 may display a predetermined number or less of characters representing the notification. In a case where the notification is a character, it is necessary to prevent the driver from being distracted by reading a long sentence while driving. Therefore, the predetermined number is a smaller number that can identify calling attention such as 2 to 4 and the number of characters used for a road sign. Examples of the small number of characters include characters such as “STOP”, “DECELERATION”, and “DETOUR”. For example, the character may be a character used for a road sign. Examples of the character used for the road sign include “SLOW DOWN” and “HALT”. Specifically, for example, in a case where an instruction regarding driving relevant to the difference is displayed as described in the first example embodiment, the output control unit 203 may display a road sign relevant to the instruction regarding driving. As described in the first example embodiment, the instruction regarding driving may be represented by a graphic of at least one of a color, a shape, and a pattern. As described in the first example embodiment, the difference between the puddle, the accumulated snow, and the fallen rock may be represented by a graphic of at least one of a color, a shape, and a pattern. The detected depth of the puddle, the depth of the accumulated snow, and the size of the fallen rock may be represented by at least one graphic of a color, a shape, and a pattern. In this way, the driver can confirm danger or instructions regarding driving at a glance.

### Notification According to Risk Level

As described above, the head-up display 22 displays the information so as to be superimposed on the road actually viewed by the driver. The display position of the notification or the notification may be changed according to the risk level of the current road in order to prevent the display of the head-up display 22 from interfering with driving. For example, the determination unit 204 determines the risk level based on a difference between a video in a case where the situation of the road is good and a video of the current road. A method of expressing the risk level is not particularly limited. Then, based on the risk level, the output control unit 203 displays the display region of the head-up display 22 at a position relevant to the risk level. For example, the output control unit 203 performs displaying at a position more conspicuous to the driver as the risk level is higher, and performs displaying at a position not blocking the view of the driver as the risk level is lower. The output control unit 203 may perform notification based on the difference based on the risk level as notification based on the difference. The output control unit 203 may not perform notification based on the difference in a case where the risk level is low.

Here, an example in which the display position of the notification and the notification change depending on the risk level will be specifically described by taking as an example a case of two levels where the risk level is high and low.

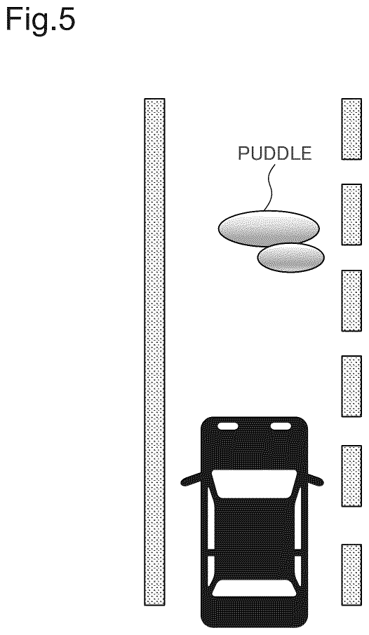

First, a case where the depth of the puddle is detected will be described as an example. FIG. 5 is an explanatory diagram illustrating an example of a current road with a puddle. There is a puddle on the current road. For example, the imaging device 21 installed in the vehicle images a road on which the vehicle is traveling.

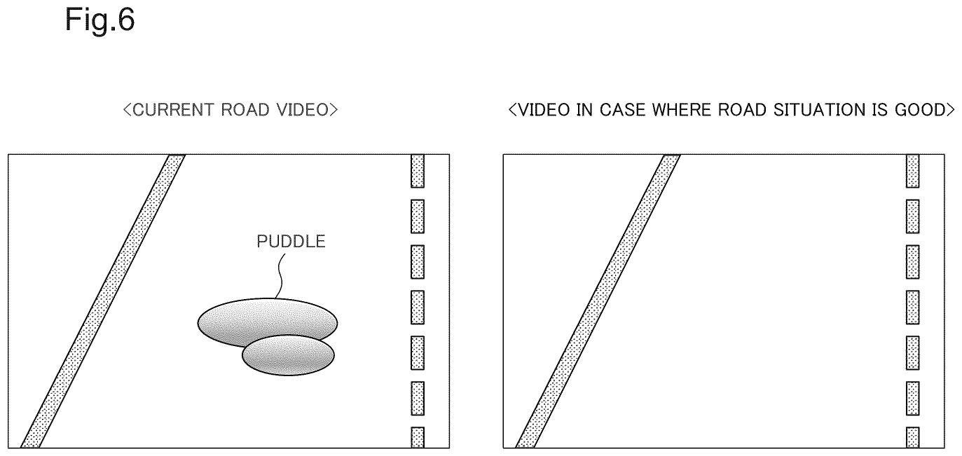

FIG. 6 is an explanatory diagram illustrating a comparative example of a video of the current road and a video of a road in a case where the situation of the road is good. In FIG. 6, the detection unit 202 detects a difference between the video of the road in a case where the situation of the road is good and the video of the current road. In FIG. 6, the detection unit 202 detects a puddle. Furthermore, the detection unit 202 detects the depth of the puddle.

For example, the determination unit 204 may determine the risk level according to a comparison result between the depth of the puddle and a threshold. The determination unit 204 determines that the risk level is higher as the depth of the puddle is deeper, and determines that the risk level is lower as the depth of the puddle is shallower. In the case of two levels where the risk level is high and low, the determination unit 204 determines that the risk level is high when the depth of the puddle is equal to or greater than the threshold, and determines that the risk level is low when the depth of the puddle is less than the threshold.

In a case where the risk level is low, the output control unit 203 displays a notification based on the difference for the driver in a predetermined region of the display region of the head-up display 22. The predetermined region is displayed in a region that is less likely to block the field of view, such as a region within 0 cm to several tens of centimeters from the hood side of the windshield. Several tens of centimeters is about 30 cm to 50 cm. The region that is less likely to block the field of view may be a region determined for each driver based on the position of the driver's head, the position of the driver's face, and the position of the driver's eyes.

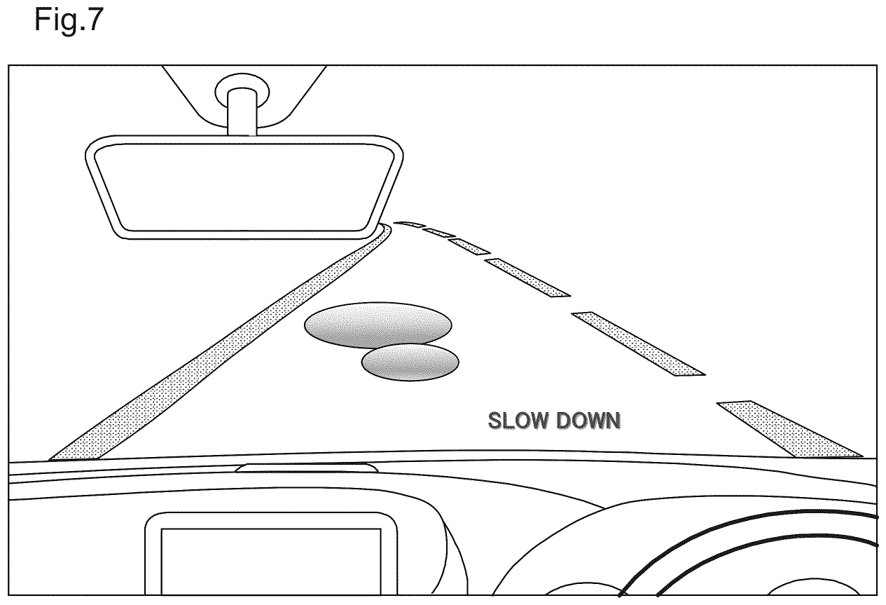

FIG. 7 is an explanatory diagram illustrating a display example in a case where the risk level is determined to be low based on the depth of the puddle. In FIG. 7, the output control unit 203 displays “SLOW” as a notification based on the difference to the driver in a region within a range from 0 cm to several tens of centimeters from the hood side of the windshield in the display region of the head-up display 22.

On the other hand, for example, in a case where the risk level is high, the output control unit 203 may display a notification based on the difference to the driver at a position relevant to the difference in the display region of the head-up display 22. The position relevant to the difference is, for example, a position overlapping the difference in a case where viewed by the driver. The position relevant to the difference is a position in the vicinity of a position where there is a difference.

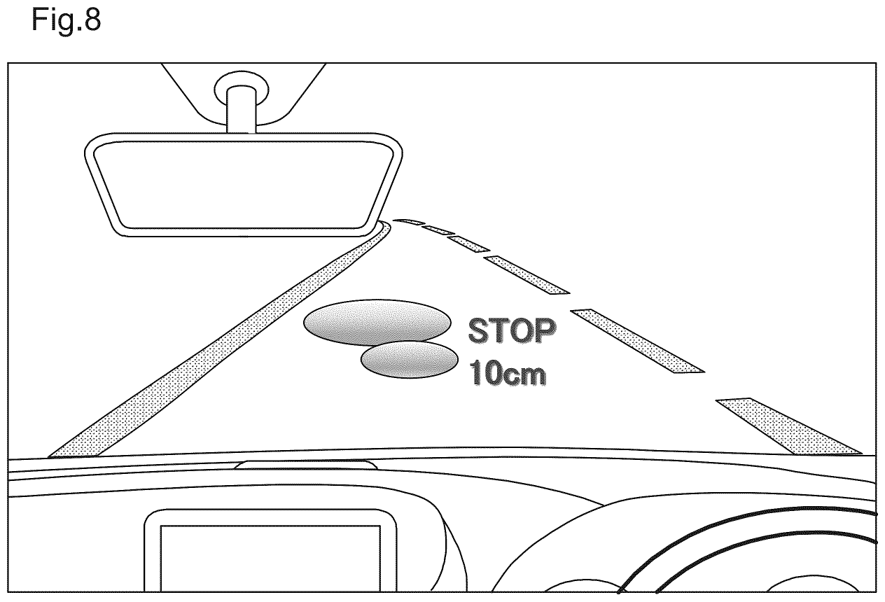

FIG. 8 is an explanatory diagram illustrating a display example in a case where the risk level is determined to be high based on the depth of the puddle. In FIG. 8, the output control unit 203 displays “HALT” as a notification based on the difference to the driver at a position beside the puddle that the driver can see in the display region of the head-up display 22. The output control unit 203 also displays the depth “10 cm” of the puddle together with “HALT”. For example, characters of “HALT” and “10 cm” in FIG. 8 are larger than characters of “SLOW DOWN” in FIG. 7 in a case where the risk level is low.

In this manner, in a case of danger, the notification can be displayed at a position more easily visible to the driver. In a case where the depth of the puddle is detected, in other words, the notification is displayed at a display position relevant to the depth of the puddle.

In a case where the risk level is high, the output control unit 203 may display the difference at a position relevant to the difference in a region that is easily viewable by the driver in the display region of the head-up display 22. For example, the region that the driver can easily see may be a predetermined region or a region individually determined by the driver based on the position of the driver's head, the position of the driver's face, and the position of the driver's eyes.

Next, a case where the depth of accumulated snow is detected will be described as an example. For example, the determination unit 204 determines that the risk level is higher as the depth of accumulated snow is deeper, and determines that the risk level is lower as the depth of accumulated snow is shallower. In the case of two levels where the risk level is high and low, the determination unit 204 may determine the risk level according to the comparison result between the depth of accumulated snow and the threshold. The determination unit 204 determines that the risk level is high when the depth of accumulated snow is equal to or more than the threshold, and determines that the risk level is low when the depth of accumulated snow is less than the threshold. The display positioning may be performed similarly to the example of the puddle. In other words, in a case where the depth of accumulated snow is detected, the notification is displayed at the display position relevant to the depth of accumulated snow.

A case where the depth of a fallen rock is detected will be described as an example. For example, the determination unit 204 determines that the risk level is higher as the size of the fallen rock is larger, and determines that the risk level is lower as the size of the fallen rock is smaller. In the case of two levels where the risk level is high and low, the determination unit 204 may determine the risk level according to the comparison result between the size of the fallen rock and the threshold. The determination unit 204 determines that the risk level is high when the depth of accumulated snow is equal to or more than the threshold, and determines that the risk level is low when the depth of accumulated snow is less than the threshold. The display positioning may be performed similarly to the example of the puddle.

The output control unit 203 may change the size, color, and the like of the notification according to the risk level. For example, the output control unit 203 may display the notification larger as the risk level is higher, and may display the notification smaller as the risk level is lower. For example, the characters illustrated in FIG. 8 in a case where the risk level is high are larger than the characters illustrated in FIG. 7 in a case where the risk level is low. In a case where the notification is represented by characters, the output control unit 203 may display the notification such that the number of characters increases as the risk level increases and the number of characters decreases as the risk level decreases. In a case where the notification is represented by a color, the output control unit 203 may display the notification in a more conspicuous color as the risk level is higher and in a less conspicuous color as the risk level is lower.

The output control unit 203 may change the notification method according to the risk level. The output control unit 203 may increase the number of types of notification methods as the risk level is higher. For example, the output control unit 203 may display the notification in a case where the risk level is low in the head-up display 22, and may output the notification by sound and display the notification in a case where the risk level is high in the head-up display 22.

### Identification of Display Position

When the output control unit 203 displays a notification near a region where the driver can see a puddle, accumulated snow, a fallen rock, or the like, or in a region where the driver can easily see, there is a case where the notification overlaps important information related to dangerous driving that the driver can see in front. The important information is information that can affect the determination of the driver during driving. For example, the important information is a front vehicle, a traffic light, a pedestrian, a road sign, and the like.

Therefore, the identification unit 205 identifies a region that does not interfere with driving by the driver in the display region of the head-up display 22. Specifically, for example, the identification unit 205 identifies a region that does not overlap any of a vehicle, a traffic light, a pedestrian, and a road sign in front of the display region of the head-up display 22. Then, the output control unit 203 displays the notification in the identified region.

### Complement of Lane

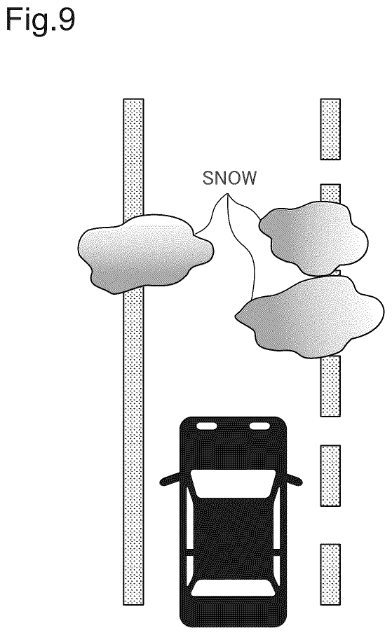

In a case where there is a snowfall, the driver may not see the lane of the road. The detection unit 202 detects that at least a part of the lane disappears on the current road as a difference between the video in a case where the situation of the road is good and the video of the current road. FIG. 9 is an explanatory diagram illustrating an example of a current road with accumulated snow. There is accumulated snow on the current road. For example, the imaging device 21 installed in the vehicle images a road on which the vehicle is traveling. Therefore, a part of the lane is hidden by snow.

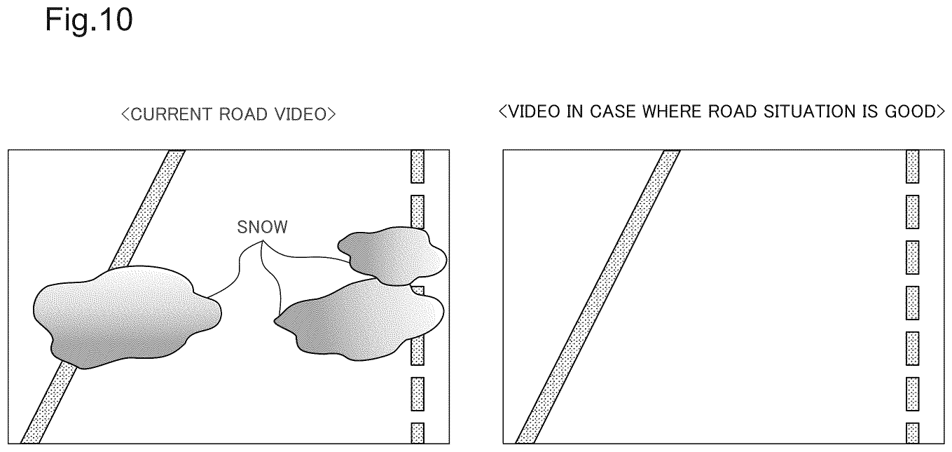

FIG. 10 is an explanatory diagram illustrating a comparative example of a video of the current road and a video of the road in a case where the situation of the road is good. In FIG. 10, the detection unit 202 detects that at least a part of the lane disappears on the current road as a difference between the video of the road in a case where the situation of the road is good and the video of the current road.

Next, in a case where it is detected that at least a part of the lane disappears in the current road, the output control unit 203 displays the lane of the road based on the video in a case where the situation of the road is good. That is, the output control unit 203 may display the lane information so as to complement the actual lane. Specifically, for example, the output control unit 203 displays a lane several meters ahead.

Here, the color of the lane to be displayed may be the same as the color of the actual lane or may be different from the color of the actual lane. For example, the color of the lane to be displayed may be a color that is not present on the current road or scenery, or a color that is not present in nature, so that the driver can be identified as a complemented lane. For example, red is a natural color such as sunset, and green is a natural color such as wood. For example, the non-natural color may be blue or the like.

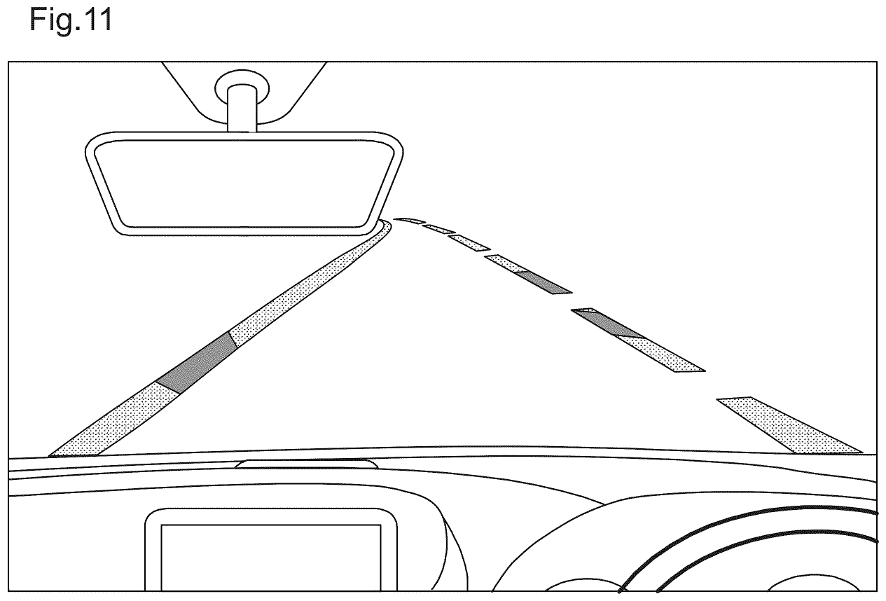

FIG. 11 is an explanatory diagram illustrating an example in which a complementary lane is displayed. In FIG. 11, the complementary lane is displayed in a color different from that of the actual lane. This allows the driver to drive while distinguishing between the lane that is actually visible and the complemented lane.

The driver can be aware that the influence of snow is strong when the number of complemented lane portions is large. Thus, complementing the lane also gives calling attention to driving.

### Display of Bypass

For example, the output control unit 203 may display guidance to a bypass based on the difference as a notification relevant to the difference. Specifically, for example, in a case where at least one of a puddle, accumulated snow, or a fallen rock is detected, the output control unit 203 displays guidance to a bypass. In particular, in a case where a fallen rock is detected, there is a case where a further fallen rock occurs or a case where the vehicle cannot pass due to the fallen rock. Therefore, in a case where a fallen rock is detected, the output control unit 203 displays guidance to a bypass.

Alternatively, the output control unit 203 displays guidance to a bypass according to the size of the puddle, the depth of the accumulated snow, and the size of the fallen rock. For example, the risk level may be used. In the case of two levels where the risk level is high and low, the output control unit 203 displays guidance to a bypass in a case where the risk level is high, and displays guidance to a bypass in a case where the risk level is low.

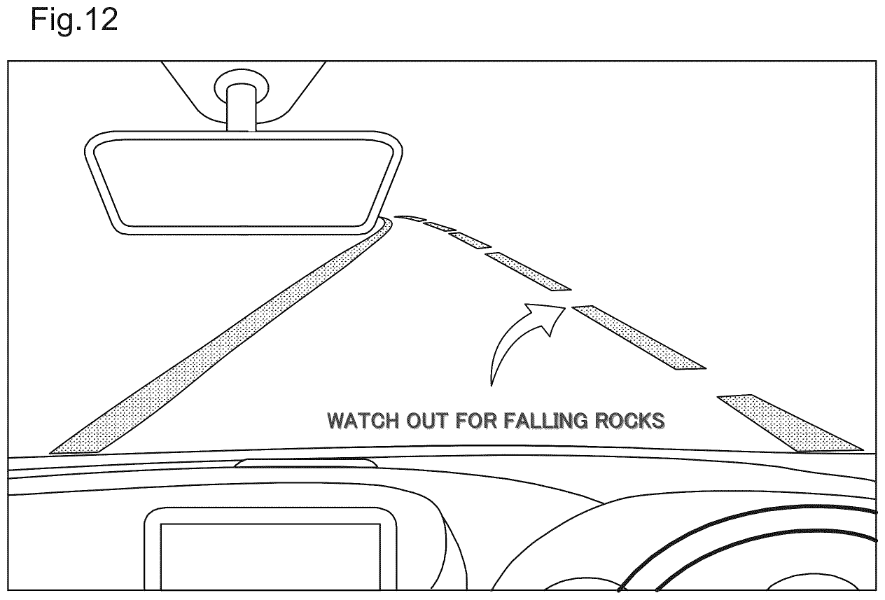

A display example of guidance to a bypass will be described with reference to FIG. 12. FIG. 12 is an explanatory diagram illustrating an example in which guidance to a bypass is displayed. For example, the output control unit 203 displays an arrow for urging a right turn as guidance to a bypass. This arrow represents an instruction to turn right in front of a section of caution against falling rock when going straight. In the output control unit 203, “WATCH OUT FOR FALLING ROCKS” is displayed as calling attention against falling rock.

For example, “WATCH OUT FOR FALLING ROCKS” is displayed in a region within a predetermined length from the hood side of the windshield, and an arrow for urging a right turn is displayed in a region that is easily seen by the driver.

Not limited to the notification regarding fallen rock, the output control unit 203 may display the notification at different positions in a case where displaying a plurality of notifications. The output control unit 203 may set priority for a plurality of notifications, and display the notification at a position that is easier for the driver to see as the priority is higher.

As the plurality of notifications, there is also a notification in a case where a plurality of different differences are detected. For example, in a case where both a fallen rock and a puddle are detected, priorities of a notification regarding the size of the fallen rock and a notification regarding the depth of the puddle may be determined based on the risk levels of the size of the fallen rock and the depth of the puddle, and a notification with a high priority may be preferentially displayed at a position that is easy for the driver to see.

A traffic system 23 may be able to present a route depending on the situation of fallen rock. Therefore, the output control unit 203 notifies the traffic system 23 that a fallen rock has been detected. As a result, another route can be proposed to another vehicle in advance.

The present invention is not limited to the example in which a fallen rock is detected, and the output control unit 203 may notify the traffic system 23 in a case where accumulated snow having a predetermined depth or more or a puddle having a predetermined size or more is detected.

### Flowchart

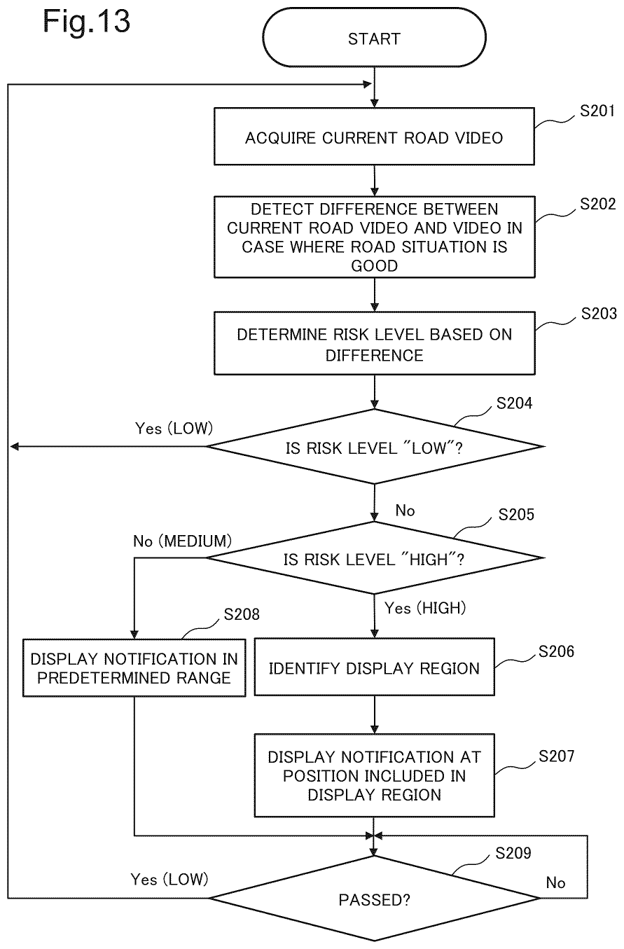

FIG. 13 is a flowchart illustrating an operation example of the driving assistance system 20 according to the second example embodiment. In FIG. 13, a case where the risk level is in three stages of “low”, “medium”, and “high” will be described as an example.

The acquisition unit 201 acquires a video of the current road (step S201). The detection unit 202 detects a difference between the video of the current road and the video in a case where the situation of the road is good (step S202). The determination unit 204 determines a risk level based on the difference (step S203).

The determination unit 204 determines whether the risk level is “low” (step S204). In a case where the risk level is “low” (step S204: Yes), the process returns to step S201. In a case where the risk level is not “low” (step S204: No), the determination unit 204 determines whether the risk level is “high” (step S205).

In a case where the risk level is “high” (step S205: Yes), the output control unit 203 identifies a display region that does not overlap with important information in a region that is easily viewable by the driver in the display region of the head-up display 22 (step S206). Next, the output control unit 203 displays a notification based on the difference at a position included in the display region (step S207), and proceeds to step S209.

On the other hand, in a case where the risk level is not “high” (step S205: No), the output control unit 203 displays a notification based on the difference within a predetermined range in the display region of the head-up display 22 (step S208), and proceeds to step S209.

For example, the output control unit 203 determines whether a portion where the difference is detected has passed (step S209). In a case where the vehicle has passed (step S209: Yes), the process returns to step S201. In a case where the vehicle has not passed through (step S209: No), the process returns to step S209.

As described above, in the second example embodiment, the driving assistance system 20 determines the risk level of the current road based on the difference between the video of the current road and the video in a case where the situation of the road is good, and displays the notification at a position overlapping the difference or a position near the difference in the display region of the head-up display 22 as the risk level is higher. In a case where the risk level is low, the driving assistance system 20 displays a notification in a predetermined region that is less likely to block the field of view, such as a region within several tens of centimeters from 0 to 30 cm or 50 cm from the hood side of the windshield, in the display region of the head-up display 22. As a result, the position of the notification can be changed according to the risk level. Therefore, driving safety can be further achieved.

The driving assistance system 20 identifies a region that does not interfere with driving by the driver in the display region of the head-up display 22, and displays a notification at a position within the identified region, the position relevant to the difference. As a result, it is possible to present danger in front of the eyes while preventing obstruction of the field of view at the time of driving, and to achieve more safety of driving.

As described above, in the case of the head-up display 22, information is superimposed on the actual road viewed by the driver, and thus, there is a possibility that the field of view during driving is obstructed. In a case where the sentence is displayed in a long sentence or the like, the driver may be distracted at the time of driving by reading the sentence. Therefore, the driving assistance system 20 may display graphics of at least one of a color, a shape, and a pattern representing the detected difference. As a result, danger can be expressed by universal design such as color, shape, and pattern. Therefore, since the driver can confirm at a glance what kind of danger is in front of the driver's eyes, it is possible to achieve more safety of driving.

In a case where the difference is a puddle, the driving assistance system 20 displays graphics of at least one of a color, a shape, and a pattern representing the size of the puddle. This makes it possible to express the danger of puddles in a universal design like color, shape, and pattern. Therefore, since the driver can confirm the size of the puddle at a glance, it is possible to achieve safer driving.

In a case where the difference is accumulated snow, the driving assistance system 20 displays at least one graphic of a color, a shape, and a pattern representing the depth of the accumulated snow. As a result, it is possible to express the danger of accumulated snow in a universal design like color, shape, and pattern. Therefore, since the driver can confirm the depth of accumulated snow at a glance, the driver can drive more safely.

In a case where the difference is a fallen rock, the driving assistance system 20 displays at least one graphic of a color, a shape, and a pattern representing the size of the fallen rock. As a result, the driver can confirm the size of the fallen rock at a glance, so that the danger of the fallen rock can be expressed by universal design like color, shape, and pattern by driving. Therefore, it is possible to achieve further safety.

The driving assistance system 20 displays an instruction regarding driving relevant to the difference as a notification based on the difference. The driving assistance system 20 may display a road sign relevant to the instruction regarding driving as the instruction. As a result, the driver can immediately recognize the instruction and the road sign relevant to the instruction, so that the driver can drive more safely.

The driving assistance system 20 displays a lane of the road based on the video in a case where the situation of the road is good. As a result, even if the lane on the actual road is hidden, the driver can drive more safely by driving along the displayed lane.

The driving assistance system 20 displays guidance to a bypass according to the difference. As a result, in a case where guidance to a bypass is displayed, the driver can drive along the guidance. Therefore, it is possible to avoid danger.

In a case where a fallen rock is detected, the driving assistance system 20 notifies the traffic system 23 that a fallen rock is detected. As a result, it is possible to notify another vehicle of the situation of falling rocks in advance, and it is possible to achieve safe driving.

The description of each example embodiment is ended. The example embodiments may be used in combination as appropriate. For example, although various display methods have been described in each example embodiment, the display methods may be appropriately combined. The output control unit 203 may perform output of another output device together with display of the head-up display 22. For example, the output control unit 203 may control sound output by the sound output device together with display of the head-up display 22.

The example embodiments are not limited to the examples described above, and various modifications can be made. The configurations of the driving assistance systems 10 and 20 in the example embodiments are not particularly limited. For example, the driving assistance systems 10 and 20 may be achieved by one device such as one server. In a case where each functional unit of the driving assistance systems 10 and 20 is achieved by one device, for example, one device may be referred to as a driving assistance device, an information processing device, or the like, and is not particularly limited. Alternatively, the driving assistance systems 10 and 20 in the example embodiments may be achieved by devices different for each function or data. For example, each functional unit may be configured by a plurality of servers and be implemented as the driving assistance systems 10 and 20.

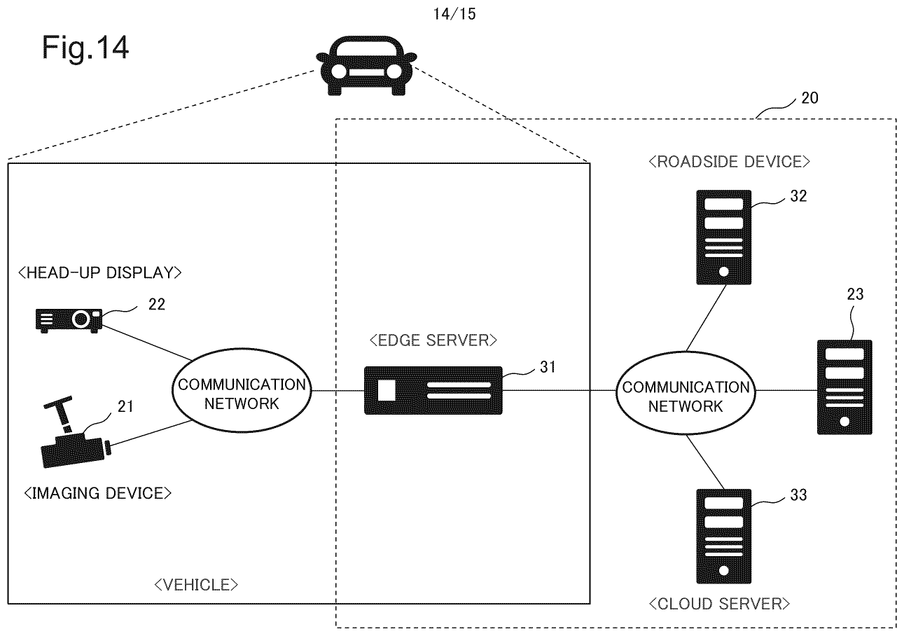

FIG. 14 is an explanatory diagram illustrating an example in which the driving assistance system 20 includes a plurality of servers. In FIG. 14, the driving assistance system 20 includes an edge server 31, a roadside device 32, and an edge server 31.

Which functional unit or DB each device included in the driving assistance system 20 has is not particularly limited.

For example, the edge server 31 in the vehicle includes an output control unit 203. The roadside device 32 may include a comparison video DB 2002. A cloud server 33 may include an acquisition unit 201, a detection unit 202, a determination unit 204, an identification unit 205, and a captured video DB 2001. In such a case, the edge server 31 in the vehicle sequentially transmits the video captured by the imaging device 21 to the cloud server 33, and controls display on the head-up display 22. The cloud server 33 acquires the current video from the edge server 31, acquires the video in a case where the situation of the road is good from the roadside device 32, and performs various processes.

For example, the edge server 31 in the vehicle includes an output control unit 203. The roadside device 32 may include the comparison video DB 2002 and the imaging device 21 that captures a current road. A cloud server 33 may include an acquisition unit 201, a detection unit 202, a determination unit 204, an identification unit 205, and a captured video DB 2001. In such a case, the edge server 31 in the vehicle controls display on the head-up display 22. The roadside device 32 sequentially transmits a video captured by the imaging device 21 and a video in a case where the state of the road is good. The cloud server 33 acquires a current video and a video in a case where the situation of the road is good from the roadside device 32, and performs various processes.

The present invention is not limited to the example of FIG. 14, and the driving assistance system 20 may include the edge server 31 and the cloud server 33. The present invention is not limited to the example of FIG. 14, and the driving assistance system 20 may include the roadside device 32 and the edge server 31. For example, the edge server 31 in the vehicle includes an output control unit 203. The roadside device 32 may include an acquisition unit 201, a detection unit 202, a determination unit 204, an identification unit 205, a captured video DB 2001, and an imaging device 21 that includes a comparison video DB 2002 and captures a current road. The edge server 31 in the vehicle controls display on the head-up display 22. The roadside device 32 performs various processes and instructs the edge server 31 to perform an output.

In each example embodiment, each piece of information and each DB may include part of the information described above. Each piece of information and each DB may include information other than the above-described information. Each piece of information or each DB may be divided into a plurality of DBs or a plurality of pieces of information in more detail. As described above, a method of achieving each piece of information and each DB is not particularly limited.

Each display is an example, and is not particularly limited. In each display, information (not illustrated) or the like may be added.

The processing of generating information and the like to be displayed on the head-up display 22 may be performed by the output control unit 203. This processing may be performed by the head-up display 22.

### Hardware Configuration Example of Computer

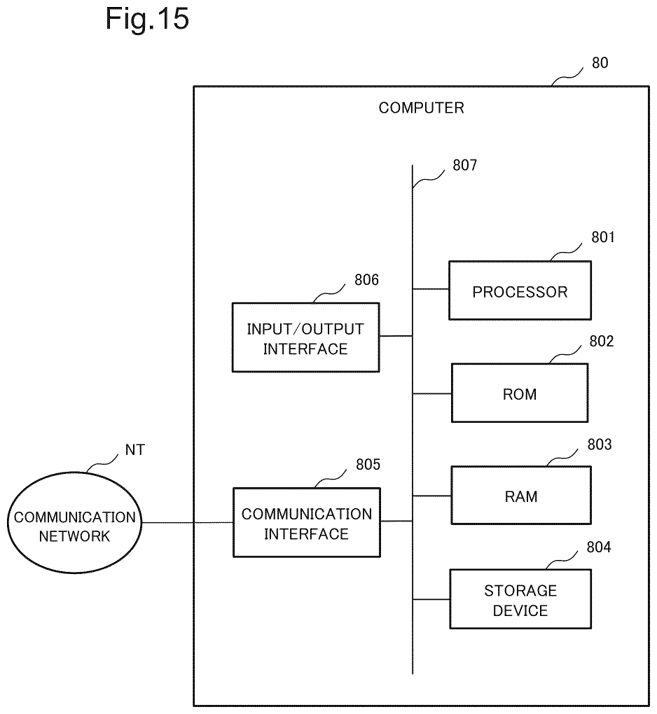

Next, a hardware configuration example in a case where each device in the driving assistance systems 10 and 20 described in each example embodiment is achieved by a computer will be described. FIG. 15 is an explanatory diagram illustrating an exemplary hardware configuration of a computer. For example, part or all of each device can be achieved by using any combination of a computer 80 and the program as illustrated in FIG. 15.

The computer 80 includes, for example, a processor 801, a read only memory (ROM) 802, a random access memory (RAM) 803, and a storage device 804. The computer 80 includes a communication interface 805 and an input/output interface 806. The components are connected via a bus 807. The number of each component is not particularly limited, and each component is one or more.

The processor 801 controls the entire computer 80. Examples of the processor 801 include a central processing unit (CPU), a digital signal processor (DSP), and a graphics processing unit (GPU). The computer 80 includes the ROM 802, the RAM 803, the storage device 804, and the like as storage units. Examples of the storage device 804 include a semiconductor memory such as a flash memory, a hard disk drive (HDD), a solid state drive (SSD), and the like. For example, the storage device 804 stores an operating system (OS) program, an application program, a program according to each example embodiment, and the like. Alternatively, the ROM 802 stores an application program, a program according to each example embodiment, and the like. The RAM 803 is used as a work area of the processor 801.

The processor 801 loads a program stored in the storage device 804, the ROM 802, or the like. The processor 801 executes each process coded in the program. The processor 801 may download various programs via the communication network NT. The processor 801 functions as part or all of the computer 80. The processor 801 may execute processes or instructions in the flowchart illustrated based on the program.

The communication interface 805 is connected to the communication network NT such as a local area network (LAN) or a wide area network (WAN) through a wireless or wired communication line. The communication network NT may include a plurality of communication networks NT. As a result, the computer 80 is connected to an external device or an external computer 80 via the communication network NT. The communication interface 805 manages an interface between the communication network NT and the inside of the computer 80. The communication interface 805 controls an input/output of data from the external device or the external computer 80.

The input/output interface 806 is connected to at least any one of an input device, an output device, and an input/output device. The connection method may be wireless or wired. Examples of the input device include a keyboard, a mouse, and a microphone. Examples of the output device include a display device, a lighting device, and a sound output device that outputs a sound. Examples of the input/output device include a touch panel display. The input device, the output device, the input/output device, and the like may be built in the computer 80 or may be externally attached.

The hardware configuration of the computer 80 is an example.

The computer 80 may have some components illustrated in FIG. 15. The computer 80 may have components other than those illustrated in FIG. 15. For example, the computer 80 may include a drive device or the like. The processor 801 may read a program or data stored in a recording medium attached to a drive device or the like into the RAM 803. Examples of the non-transitory tangible recording medium include an optical disk, a flexible disk, a magnetic optical disk, and a Universal Serial Bus (USB) memory. As described above, for example, the computer 80 may include an input device such as a keyboard and a mouse. The computer 80 may include an output device such as a display. The computer 80 may include an input device, an output device, and an input/output device.

The computer 80 may include various sensors (not illustrated). The type of the sensor is not particularly limited. The computer 80 may include an imaging device capable of capturing images and videos.

The description of the hardware configuration of each device is ended. There are various modifications in a method of achieving each device. For example, each device may be achieved by any combination of a computer and a program different for each component. A plurality of components included in each device may be achieved by any combination of one computer and a program.

Part or all of each component of each device may be achieved by an application specific circuit. Part or all of each component of each device may be achieved by a general-purpose circuit including a processor such as a field programmable gate array (FPGA). Part or all of each component of each device may be achieved by a combination of an application specific circuit, a general-purpose circuit, and the like. The circuit may be a single integrated circuit. Alternatively, the circuit may be divided into a plurality of integrated circuits. The plurality of integrated circuits may be configured by being connected via a bus or the like.

In a case where part or all of each component of each device is achieved by a plurality of computers, circuits, and the like, the plurality of computers, circuits, and the like may be disposed in a centralized manner or in a distributed manner.

The driving assistance method described in each example embodiment is achieved by the driving assistance system. For example, the driving assistance method is achieved by a computer such as a server or a terminal device executing a program prepared in advance.

The program described in each example embodiment is recorded in a computer-readable recording medium such as an HDD, an SSD, a flexible disk, an optical disk, a magnetic optical disk, and a USB memory. The program is executed by being read from the recording medium by the computer. The program may be distributed via the communication network NT.

Each component of the driving assistance system in each example embodiment described above may be achieved by dedicated hardware such as a computer. Alternatively, each component may be achieved by software. Alternatively, each component may be achieved by a combination of hardware and software.

While the present disclosure has been particularly shown and described with reference to each of example embodiments, the present disclosure is not limited to the above example embodiments. The configurations and details of the present disclosure may include example embodiments to which various changes that can be grasped by those of ordinary skill in the art without departing from the scope of the present disclosure are applied. The present disclosure may include example embodiments in which the matters described in the present specification are appropriately combined or replaced as necessary. For example, the matters described using a specific example embodiment can be applied to other example embodiments as long as no contradiction occurs. For example, although the plurality of operations is described in order in the form of a flowchart, the order of description does not limit the order in which the plurality of operations is executed. Therefore, when each example embodiment is implemented, the order of the plurality of operations can be changed within a range that does not interfere with the content.

Some or all of the above example embodiments can also be described as the following Supplementary Notes. However, some or all of the above example embodiments are not limited to the following.

### Supplementary Note 1

A driving assistance system including:
an acquisition means for acquiring a video of a current road;
a detection means for detecting a difference between a video in a case where a situation of the road is good and the video of the current road; and
an output control means for displaying a notification based on the difference to a user at a position relevant to the difference in a display region of a head-up display.

### Supplementary Note 2

The driving assistance system according to Supplementary Note 1, including:
a determination means for determining a risk level of the current road based on the difference, in which
the output control means displays the notification at a position overlapping with the difference in a display region of the head-up display as the risk level is higher.

### Supplementary Note 3

The driving assistance system according to Supplementary Note 1 or 2, including:
an identification means for identifying a region that does not interfere with driving by the user in a display region of the head-up display, in which
the output control means
displays the notification at a position relevant to the difference, the position being within the identified region in a display region of the head-up display.

### Supplementary Note 4

The driving assistance system according to any one of Supplementary Notes 1 to 3, in which
the output control means displays at least one graphic of a color, a shape, and a pattern representing the detected difference.

### Supplementary Note 5

The driving assistance system according to Supplementary Note 4, in which
in a case where the difference is a puddle, the detection means detects a size of the puddle from the difference, and
the output control means displays at least one graphic of a color, a shape, and a pattern representing a size of the puddle.

### Supplementary Note 6

The driving assistance system according to Supplementary Note 4, in which
in a case where the difference is accumulated snow, the detection means detects a depth of the accumulated snow from the difference, and
the output control means displays at least one graphic of a color, a shape, and a pattern representing the depth of the accumulated snow.

### Supplementary Note 7

The driving assistance system according to Supplementary Note 4, in which
in a case where the difference is a fallen rock, the detection means detects a size of the fallen rock from the difference, and
the output control means displays at least one graphic of a color, a shape, and a pattern representing the size of the fallen rock.

### Supplementary Note 8

The driving assistance system according to any one of Supplementary Notes 1 to 7, in which
the output control means displays an instruction regarding driving relevant to the difference.

### Supplementary Note 9

The driving assistance system according to Supplementary Note 8, in which
the output control means displays a road sign relevant to an instruction regarding the driving.

### Supplementary Note 10

The driving assistance system according to any one of Supplementary Notes 1 to 9, in which
the output control means displays a lane of the road based on the video in a case where a situation of the road is good.

### Supplementary Note 11

The driving assistance system according to any one of Supplementary Notes 1 to 10, in which
the output control means displays guidance to a bypass according to the difference.

### Supplementary Note 12

The driving assistance system according to any one of Supplementary Notes 1 to 11, in which
the output control means notifies a traffic system that a fallen rock has been detected in a case where the fallen rock is detected.

### Supplementary Note 13

The driving assistance system according to any one of Supplementary Notes 1 to 12, in which
the acquisition means acquires the video of the current road from an imaging device attached to a vehicle.

### Supplementary Note 14

The driving assistance system according to any one of Supplementary Notes 1 to 13, in which
the acquisition means acquires the video of the current road from an imaging device installed on the road.

### Supplementary Note 15

A driving assistance method including:
acquiring a video of a current road;
detecting a difference between a video in a case where a situation of the road is good and the video of the current road; and
displaying a notification based on the difference to a user at a position relevant to the difference in a display region of a head-up display.

### Supplementary Note 16

A non-transitory computer-readable recording medium recording a program causing a computer to execute:
acquiring a video of a current road;
detecting a difference between a video in a case where a situation of the road is good and the video of the current road; and
displaying a notification based on the difference to a user at a position relevant to the difference in a display region of a head-up display.

### Supplementary Note 17

A program causing a computer to execute:
acquiring a video of a current road;
detecting a difference between a video in a case where a situation of the road is good and the video of the current road; and
displaying a notification based on the difference to a user at a position relevant to the difference in a display region of a head-up display.

### REFERENCE SIGNS LIST

10, 20 driving assistance system
21 imaging device
22 head-up display
23 traffic system
31 edge server
32 roadside device
33 cloud server
80 computer
101, 201 acquisition unit
102, 202 detection unit
103, 203 output control unit
204 determination unit
205 identification unit
801 processor
802 ROM
803 RAM
804 storage device
805 communication interface
806 input/output interface
807 bus
2001 captured video DB
2002 comparison video DB
NT communication network

What is claimed is:

1. A driving assistance system comprising:
at least one memory storing instructions; and
at least one processor configured to execute the instructions to:
acquire a video of a current road;
detect a difference between a video in a case where a situation of the road is good and the video of the current road; and
display a notification based on the difference to a user at a position relevant to the difference in a display region of a head-up display.

2. The driving assistance system according to claim 1, wherein the at least one processor is further configured to execute the instructions to:
determine a risk level of the current road based on the difference, wherein; and
display the notification at a position overlapping with the difference in a display region of the head-up display as the risk level is higher.

3. The driving assistance system according to claim 1 wherein the at least one processor is further configured to execute the instructions to:
identify a region that does not interfere with driving by the user in a display region of the head-up display; and
display the notification at a position relevant to the difference, the position being within the identified region in a display region of the head-up display.

4. The driving assistance system according to claim 1, wherein the at least one processor is further configured to execute the instructions to:
display at least one graphic of a color, a shape, and a pattern representing the detected difference.

5. The driving assistance system according to claim 4, wherein the at least one processor is further configured to execute the instructions to:
in a case where the difference is a puddle, detect a size of the puddle from the difference; and
display at least one graphic of a color, a shape, and a pattern representing a size of the puddle.

6. The driving assistance system according to claim 4, wherein the at least one processor is further configured to execute the instructions to:
in a case where the difference is accumulated snow, detect a depth of the accumulated snow from the difference, and
display at least one graphic of a color, a shape, and a pattern representing the depth of the accumulated snow.

7. The driving assistance system according to claim 4, wherein the at least one processor is further configured to execute the instructions to:
in a case where the difference is a fallen rock, detect a size of the fallen rock from the difference; and
display at least one graphic of a color, a shape, and a pattern representing the size of the fallen rock.

8. The driving assistance system according to claim 1, wherein the at least one processor is further configured to execute the instructions to:
display an instruction regarding driving relevant to the difference.

9. The driving assistance system according to claim 8, wherein the at least one processor is further configured to execute the instructions to:
display a road sign relevant to an instruction regarding the driving.

10. The driving assistance system according to claim 1, wherein the at least one processor is further configured to execute the instructions to:
display a lane of the road based on the video in a case where a situation of the road is good.

11. The driving assistance system according to claim 1, wherein the at least one processor is further configured to execute the instructions to:
display guidance to a bypass according to the difference.

12. The driving assistance system according to claim 1, wherein the at least one processor is further configured to execute the instructions to:
notify a traffic system that a fallen rock has been detected in a case where the fallen rock is detected.

13. The driving assistance system according to claim 1, wherein the at least one processor is further configured to execute the instructions to:
acquire the video of the current road from an imaging device attached to a vehicle.

14. The driving assistance system according to any claim 1, wherein the at least one processor is further configured to execute the instructions to:
acquire the video of the current road from an imaging device installed on the road.

15. A driving assistance method comprising:
acquiring a video of a current road;
detecting a difference between a video in a case where a situation of the road is good and the video of the current road; and
displaying a notification based on the difference to a user at a position relevant to the difference in a display region of a head-up display.

16. A non-transitory computer-readable recording medium recording a program causing a computer to execute:
acquiring a video of a current road;
detecting a difference between a video in a case where a situation of the road is good and the video of the current road; and
displaying a notification based on the difference to a user at a position relevant to the difference in a display region of a head-up display.
